(19) United States
(12) Patent Application Publication
(10) Pub. No.: US 2024/0331049 A1
(43) Pub. Date: Oct. 3, 2024

(54) COMPUTER SYSTEMS AND METHODS FOR INSURANCE VERIFICATION

(71) Applicant: Modives Enterprise LLC, Huntersville, NC (US)

(72) Inventors: Frederick Waite, Huntersville, NC (US); Justin Silver, Wyckoff, NJ (US)

(73) Assignee: Modives Enterprise LLC, Huntersville, NC (US)

(21) Appl. No.: 18/620,369

(22) Filed: Mar. 28, 2024

Related U.S. Application Data
(60) Provisional application No. 63/455,028, filed on Mar. 28, 2023.

(51) Int. Cl. G06Q 40/08

(52) U.S. Cl. CPC G06Q 40/08

(57) ABSTRACT

A computer-implemented method and system for verifying and/or monitoring adequacy of insurance for a contemplated transaction between a client and a business entity via a third party verification computer system. The verification computer system sends a packet request to a client device requesting certain insurance company information to enable secure electronic access to a client's identified insurance company to request, and retrieve, certain insurance data relating to either a contemplated and/or completed transaction between the client and the business entity having certain insurance requirements. The verification system then analyzes the data provided by the insurance company (which may use one or more Artificial Intelligence (AI) and Machine Learning (ML) techniques) to determine whether the client has adequate insurance coverage for the contemplated and/or monitored transaction, and to provide notification of any issues/discrepancies, as well as any remediation solutions.

### CROSS REFERENCE TO RELATED APPLICATIONS

This application claims priority to U.S. Patent Application Ser. No. 63/455,028 filed Mar. 28, 2023 which is incorporated herein by reference in its entirety.

### BACKGROUND

### Field of the Invention

The illustrated embodiment relates generally to electronic insurance verification, and more particularly to an electronic insurance verification and monitoring computer system and method using one or more Artificial Intelligence and/or Machine Learning techniques.

### Description of Related Art

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Verification and/or monitoring of various statuses is required as part of many life-event driven events. Currently, the verification of a status in conjunction life-driven events, such as the verification of in-force automobile insurance during the purchase of a new car, is a manual operation requiring either manually accessing a database or, worse, obtaining verification through a telephone call that, on average, lasts 15-30 minutes. Manual verification of life-driven events is inefficient and, further, ordinarily not confirmed by another person or generating an independent record. Examples of manual verifications that currently occur during such life-driven events include: 1) verifying in-force automobile insurance when renting, leasing or purchasing an automobile; 2) verifying in-force insurance when leasing personal property; and 3) verifying in-force insurance when purchasing real property.

Therefore, a heretofore unaddressed need exists in the art to address the aforementioned deficiencies and inadequacies.

### SUMMARY

This invention in certain aspects discloses a novel method and system for near real time or real time verification of a preexisting status during the occurrence of a life event, such as whether a party has in-force insurance (e.g., automobile or property/casualty insurance).

The novel system disclosed herein is preferably based upon an API ecosystem comprising API & data catalogues accessible by (i) parties seeking to verify a status, (ii) consumers seeking to have such status verified, and (iii) administration and configuration personnel. The illustrated embodiments enable for near real time verification and/or monitoring of a party's status, plus additional features and functionality customizable to the nature of the transaction for which verification and/or monitoring is sought.

The verification and/or monitoring process in accordance with the illustrated embodiments, generally, is initiated by the dealer or property manager during the transaction by sending a text message to the consumer with a link to the system that allows the consumer to input relevant data regarding the consumer's identity, insurance carrier, credentials and permissions for that carrier's site, data and documents. The system, utilizing the consumer's provided information, automatically (1) accesses the carrier's website or database through an RPA, or API, to the carrier's policy or coverage data, (2) authenticates in-force insurance and policy information, and (3) generates a verification message to confirm the existence of such in-force insurance. The verification message is then stored as part of the transaction documents by the dealer/property manager should a question arise at a later date. Upon completion of the verification and/or monitoring process, the system may add information from the verification/monitoring to a structured transactional database that includes details related to (A) the life event for which the record was created, (B) consumer contact information, (C) dealer or property manager contact information, (D) insurance policy information, and (E) carrier/agent contact information.

In accordance with certain illustrated embodiments, the system is further configured and operative that upon determination of inactive, adequate and/or accurate insurance remediation of such determinations is provided. For instance, determined mitigation opportunities may include on or more of: connection to a prior carrier to reinstate or update coverage; binding a new policy; forced placement and/or other customer-specific options.

In one aspect, the illustrated embodiments relate to a system and method for verifying and/or monitoring the existence and coverage of automobile limits during the purchase or leasing of an automobile. One embodiment may include providing the option of updating the consumer's current insurance coverage by automatically adding the purchased or leased automobile to the consumer's policy. Such an option would significantly reduce premium leakage, where the consumer fails to notify his/her insurance carrier of the purchase that would increase the consumer's premium for a period of time. Another embodiment may also include, where the automobile is leased, rented or financed, the periodic, e.g., monthly, monitoring of in-force insurance coverage for the vehicle. Another embodiment may also include the delivery of coupons and other offers through the system during the period of verification, which may be selected for redemption by the consumer. Another embodiment may also further include delivery of targeted advertising from third parties.

In another aspect, the illustrated embodiments relate to a system and method for verifying and/or monitoring the existence and coverage of property/casualty limits during the purchase or leasing of property. One embodiment may include providing the option of updating the consumer's current insurance (e.g. coverage by automatically adding the purchased or leased vehicle to the consumer's policy). Such an option would significantly reduce premium leakage, where the consumer fails to notify his insurance carrier of the purchase that would increase the consumer's premium for a period of time. Another embodiment may also include, where the property is leased, the periodic, e.g., monthly, monitoring of in-force insurance coverage for the property. Another embodiment may also include the delivery of coupons and other offers relating to, and/or having a nexus to insurance verification, re-verification and/or monitoring (as described herein), which may be selected for redemption by the consumer, which determination of such coupons and offers may include the use of one or more AI/ML techniques. Another embodiment may also further include delivery of targeted advertising from third parties, which likewise may include the use of one or more AI/ML techniques. In accordance with certain illustrated embodiments, such offers, and/or targeted advertising, are not to be understood to be restricted to vehicles and/or real estate, as they may be applicable to other types of insurance opportunities, such as (but not limited to): pet insurance, health insurance, and moving services.

In another aspect, the illustrated embodiments utilize one or more Artificial Intelligence and/or Machine Learning (ML) techniques for making the determinations described herein.

In yet another aspect, the illustrated embodiments relate to a computer-implemented method and system for verifying and/or monitoring adequacy of insurance for a contemplated transaction between a client and a business entity via a third party verification computer system. The verification computer system sends a packet request to a client device requesting certain insurance company information to enable secure electronic access to a client's identified insurance company to request, and retrieve, certain insurance data relating to either a contemplated and/or completed transaction between the client and the business entity having certain insurance requirements. The verification system then analyzes the data provided by the insurance company (which may use one or more Artificial Intelligence (AI) and Machine Learning (ML) techniques) to determine whether the client has adequate insurance coverage for the contemplated and/or monitored transaction.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments.

FIG. 4 illustrates a diagram depicting an AI server utilized with one or more of the illustrated embodiments;

FIG. 5 illustrates a system level diagram depicting certain components of the illustrated embodiments;

FIG. 6 illustrates a flow chart depicting a process in accordance with the illustrated embodiments; and

FIGS. 7-9 depict various Graphical User Interfaces generated on one or more user devices in accordance with the illustrated embodiments.

### DETAILED DESCRIPTION OF THE INVENTION

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this illustrated embodiment belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

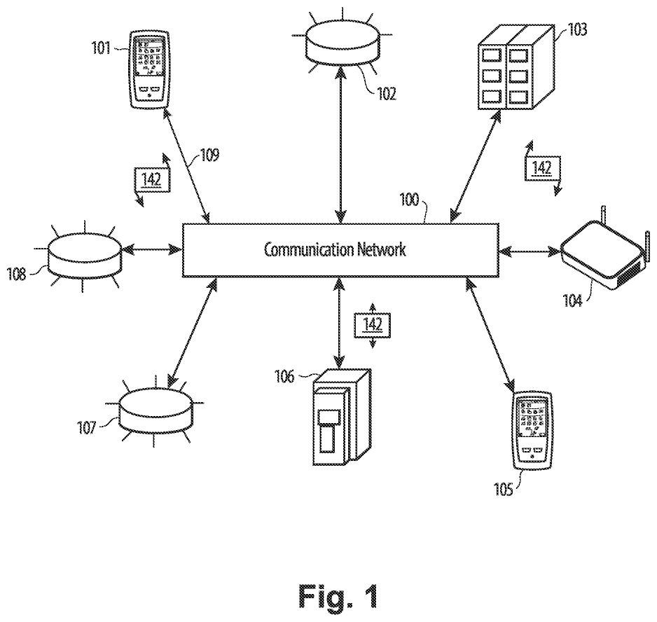

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, computing devices 103, smart phone devices 105, web servers/computer systems 106, computer systems 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the illustrated embodiments may be written in any combination of one or more programming languages, including an object oriented programming language such as Python, Golang, Ruby, ASP.NET, Java, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

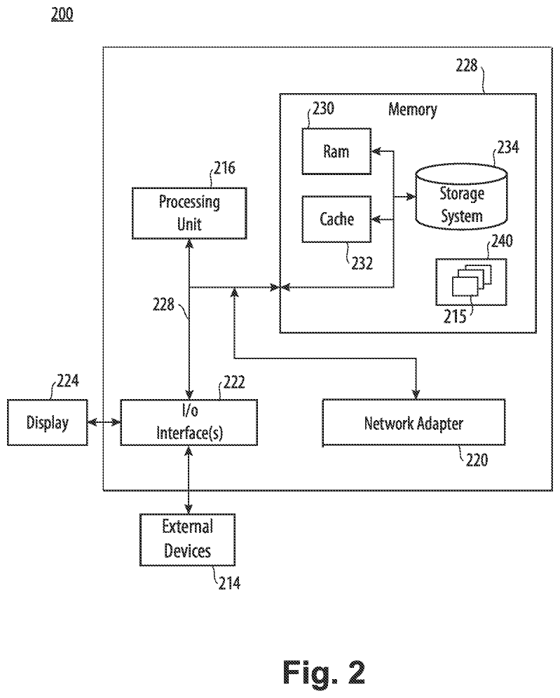

FIG. 2 is a schematic block diagram of an example network computing device 200 (e.g., client computing device 103, computer system 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality
of the illustrated embodiments described herein. Regardless, computing device 200 is capable
of being implemented and/or performing any of the functionality set forth herein, including in insurance computer system 106, verification computer system 103, and business entity computer system 107.

Computing device 200 is operational with numerous other general purpose or special purpose computing system environments or configurations. Examples of well-known computing systems, environments, and/or configurations that may be suitable for use with computing device 200 include, but are not limited to, cloud computing systems (including, but not limited to: Infrastructure as a Service (Iaas); Software as a Service (SaaS); Platform as a Service (PaaS); and Private cloud), personal computer systems, server computer systems, thin clients, thick clients, hand-held or laptop devices, multiprocessor systems, microprocessor-based systems, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices. In accordance with the illustrated embodiments, computing device 200 is configured and operative, relative insurance verification system 103, to verify, and/or monitor, adequacy of insurance for a contemplated and/or completed transaction between a client (e.g., 105) and a business entity (e.g., 107) via a third party verification computer system 103 that is an intermediatory between each of the client 105, the business entity 107 and one or more electronic systems 106 of an insurance company associated with the client, as described further below. As mentioned further below, computing device 200 is preferably configured and operative to generate and send notifications to relevant designated parties providing indication of any determined issues (e.g., inaccuracy's discrepancies, etc.), in addition to one or more recommendations to remediate said issues, relating to verification, re-verification and monitoring adequacy of insurance for a contemplated and/or completed transaction.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein, including, but not limited to verify, and monitor adequacy of insurance for a contemplated transaction between a client (e.g., 105) and a business entity (e.g., 107) via a third party verification computer system 103 that is an intermediatory between each of a client 105, a business entity 107 and one or more electronic systems 106 of an insurance company associated with the client 105, as described further below.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: big data technologies encompassing large and diverse datasets that are significant in volume, which are commonly used in machine learning, predictive modeling, and other advanced analytics to solve business problems and make informed decisions; non-relational databases (NoSQLs); Blob storage; relational databases (SQL); as well as microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with self-learning/Artificial Intelligence (AI) to verify, and/or monitor, adequacy of insurance for a contemplated and/or or completed transaction between a client 105 and a business entity 107, including determining one or more applicable insurance products and/or policy changes, and/or determining one or more change of life events for an insured client 105, amongst other determinations, as described herein. Thus, preferably integrated into an insurance verification computer system (e.g., 103) coupled to a plurality of external databases/data sources is an AI system (e.g., an Expert System) that implements machine learning and artificial intelligence algorithms to conduct one or more of the above mentioned insurance related tasks, preferably on an automated basis. For instance, the AI system may include two subsystems: a first sub-system that learns from historical data; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems.

In accordance with the illustrated embodiments described herein, artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

Also in accordance with the illustrated embodiments, an artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function. The purpose of the learning of the artificial neural network may be to determine the model parameters that minimize a loss function. The loss function may be used as an index to determine optimal model parameters in the learning process of the artificial neural network. Machine learning may be classified into supervised learning, unsupervised learning, and reinforcement learning according to a learning method. The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

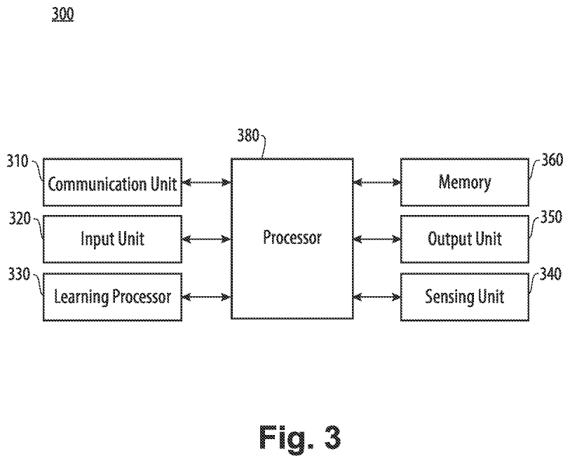

Machine learning, which is implemented as a deep neural network (DNN) including a plurality of hidden layers among artificial neural networks, is also referred to as deep learning, and the deep learning is part of machine learning. FIG. 3 illustrates an AI device 300 according to an illustrated embodiment. In accordance with the illustrated embodiments, the AI device 300 is preferably integrated into in verification computer system 103.

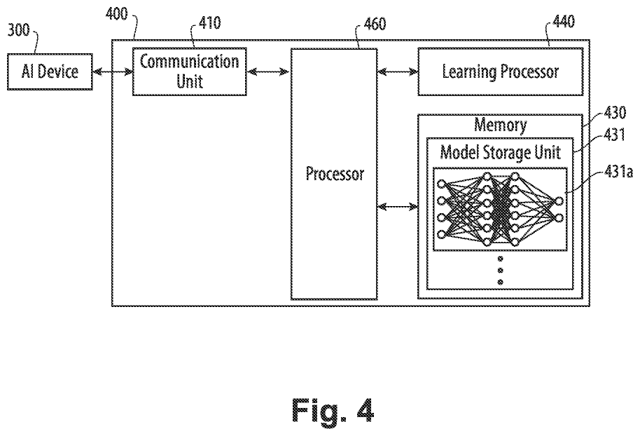

Referring now FIG. 3, in conjunction with FIGS. 1 and 2, the AI device 300 is operatively coupled to, or integrated with computing device 200, in accordance with the illustrated embodiments described herein. AI device 300 preferably includes a communication unit 310, an input unit 320, a learning processor 330, a sensing unit 340, an output unit 350, a memory 370, and a processor 380. The communication unit 310 may transmit and receive data to and from external devices such as other AI devices 300a to 300e and an AI server 400 (FIG. 4) by using wire/wireless communication technology. For example, the communication unit 310 may transmit and receive sensor information, a user input, a learning model, and a control signal to and from external devices.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of data, including, but not limited to insurance data and data relating to insured clients (e.g., public record databases) (including, but not limited to life event data). The input unit 320 may acquire a learning data for model learning and an input data to be used when an output is acquired by using learning model. The input unit 320 may acquire raw input data. In this case, the processor 380 or the learning processor 330 may extract an input feature by preprocessing the input data. The learning processor 330 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 330 may perform AI processing together with the learning processor 330 of the AI server 400, and the learning processor 330 may include a memory integrated or implemented in the AI device 300. Alternatively, the learning processor 330 may be implemented by using the memory 370, an external memory directly connected to the AI device 300, or a memory held in an external device. The sensing unit 340 may acquire at least one of internal information about the AI device 300, ambient environment information about the AI device 300, and user information by using various sensors.

The output unit 350 preferably includes a display unit for outputting/displaying relevant information to a user in accordance with the illustrated embodiments described herein. The memory 370 preferably stores data that supports various functions of the AI device 300. For example, the memory 370 may store input data acquired by the input unit 320, learning data, a learning model, a learning history, and the like.

The processor 380 preferably determines at least one executable operation of the AI device 300 based on information determined or generated by using a data analysis algorithm or a machine learning algorithm. The processor 380 may control the components of the AI device 300 to execute the determined operation. To this end, the processor 380 may request, search, receive, or utilize data of the learning processor 330 or the memory 370. The processor 380 may control the components of the AI device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. The processor 380 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 330, may be learned by the learning processor 340 of the AI server 400, or may be learned by their distributed processing. The processor 380 may collect history information including the operation contents of the AI device 300 or the user's feedback on the operation and may store the collected history information in the memory 370 or the learning processor 330 or transmit the collected history information to the external device such as the AI server 400. The collected history information may be used to update the learning model.

The processor 380 may control at least part of the components of AI device 300 so as to drive an application program stored in memory 370. Furthermore, the processor 380 may operate two or more of the components included in the AI device 300 in combination so as to drive the application program.

FIG. 4 illustrates an AI server 400 according to the illustrated embodiments. It is to be appreciated that the AI server 400 may refer to a device that learns an artificial neural network by using a machine learning algorithm or uses a learned artificial neural network. The AI server 400 may include a plurality of servers to perform distributed processing, or may be defined as a 5G network. At this time, the AI server 400 may be included as a partial configuration of the AI device 300, and may perform at least part of the AI processing together. The AI server 400 may include a communication unit 410, a memory 430, a learning processor 440, a processor 460, and the like. The communication unit 410 can transmit and receive data to and from an external device such as the AI device 300. The memory 430 may include a model storage unit 431. The model storage unit 431 may store a learning or learned model (or an artificial neural network 431a) through the learning processor 440.

The learning processor 440 may learn the artificial neural network 431a by using the learning data. The learning model may be used in a state of being mounted on the AI server 400 of the artificial neural network or may be used in a state of being mounted on an external device such as the AI device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

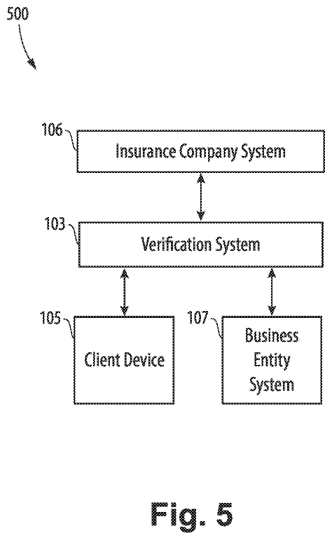

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided with below reference to FIG. 5. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With reference now to FIG. 5, shown is an exemplary generalized system 500, utilizing one or more of the aforementioned communication network 100 (FIG. 1), computing device 200 (FIG. 2), AI device 300 (FIG. 3) and AI server 400 (FIG. 4), depicting one or more illustrated embodiments for verifying, and monitoring, adequacy of insurance for a contemplated transaction between a client 105 and a business entity 107 via a third party verification computer system 103 that is an intermediatory between each of the client 105, the business entity 107 and one or more electronic systems 106 of an insurance company associated with the client 105, as described further below.

In accordance with the illustrated embodiments, reference herein to a “contemplated transaction” is to encompass any transaction between a client 105 and business entity 107 having certain insurance coverage requirements. For instance, examples of such a transaction may include transactions relating to a vehicle or real estate property. For example, with regards to a vehicle, it may encompass acquisition of a vehicle and transactions relating to vehicle loaners and/or rentals. It is to be appreciated that it may encompass enterprise rental of a plurality of vehicles (e.g., automobiles, recreational vehicles, trucks, commercial vehicles, drones, planes, and maritime vehicles (e.g., boats). It may encompass person-to-person (P2P) rental companies, such as Turo. It may further encompass gig/rideshare companies, such as, Uber and DoorDash (e.g., companies that hire non-owned auto drivers, which companies desire to ensure their drivers have their own insurance that meets company specific requirements). For instance, certain states currently require licensed drivers to have at least liability insurance but in such scenarios, the state minimums may not be enough for certain companies (e.g., Uber), thus there is a need for such a company (e.g., Uber) to verify its driver's meets its specific insurance adequacy requirements, as well as to monitor its drivers to verify they continue to meet its specific insurance requirements.

And with regard to the real estate related transactions, the illustrated embodiments are to encompass contractual arrangements between a client and business entity relating to acquisition, renting, lending (hosting) certain living spaces, including (but not limited to): houses, co-ops, apartments, boats, recreational vehicles, and other living spaces.

It is to be appreciated and understood that for ease of explanation, the illustrated embodiments described herein are discussed relative to a transaction involving a vehicle acquisition (e.g., vehicle purchase), and/or continued use of vehicle relating to a certain company having certain insurance requirements (e.g., Uber). However, the illustrated embodiments are not to be limited thereto as they may encompass one or more of the above-mentioned transaction scenarios associated with certain insurance requirements.

It is to be further appreciated and understood the objectives of the illustrated embodiments (e.g., verification system 103) are twofold: 1) to verify adequacy of certain insurance requirements related to a contemplated transaction (e.g., vehicle lease/rental/usage); and 2) to monitor a completed transactional (e.g., contractual arrangement) to ensure a client associated with a completed transaction continues to maintain the required adequate insurance requirements for that completed and ongoing transaction (e.g., vehicle lease/rental/usage).

For instance, verification of various statuses is required as part of many life-event driven events. Currently, the verification of a status in conjunction with life-driven events, such as the verification of in-force automobile insurance during the purchase of a new car, is a manual operation requiring either manually accessing a database or, worse, obtaining verification through a telephone call that, on average, lasts 15-30 minutes. Manual verification of life-driven events is inefficient and, further, ordinarily not confirmed by another person. Examples of manual verifications that currently occur during such life-driven events include: 1) verifying in-force automobile insurance when purchasing an automobile; 2) verifying in-force insurance when leasing personal property; and 3) verifying in-force insurance when purchasing real property. Therefore, a heretofore unaddressed need exists in the art to address the aforementioned deficiencies and inadequacies.

As described herein, the illustrated embodiments, in certain aspects, discloses a novel computer method and system for near real time or real time verification of a preexisting status during the occurrence of a life event, such as whether a party has in-force existing automobile or property/casualty insurance, overcoming current deficiencies and inadequacies.

With reference now to FIG. 5, shown is a generalized system 500 depicting certain components of the illustrated embodiments. For instance, shown in system 500 is an insurance verification system 103 (as described above relative to computer device 200, AI system 300 and AI server 400) communicatively coupled (via communication network 100) to one or more insurance computer systems 106 (e.g., State Farm), and to one or more business entity computer systems 107 (e.g., an automobile dealership or car livery service (e.g., Uber)) and to one or more client computing devices 105 respectively associated with a user having a contractual relationship (e.g., requiring certain insurance requirements) to the business entity associated with a business entity computer systems 107. It is to be appreciated and understood, that for ease of description purposes, the illustrated embodiment of system 500 is described relative to the verification system 103 being coupled to a single business entity 107 and user computing device 105, as well as a single insurance company computer system 106 associated with the user 105. However, the illustrated embodiments are not to be limited thereto as the verification system 103 is to be understood to be coupled to a plurality of different business entity computer systems 107 (each associated with a different business entity) and to a plurality of different client computing devices (105), as well as to a plurality of different insurance company computer systems 106. Preferably, one or more Application Programming Interfaces (APIs) and/or Robotic Process Automations (RPAs) are utilized by the verification system 103 for integrating with the insurance company computer systems 106 and business entity computer systems 107 for enabling communication and exchange of data therebetween, preferably via communications network 100.

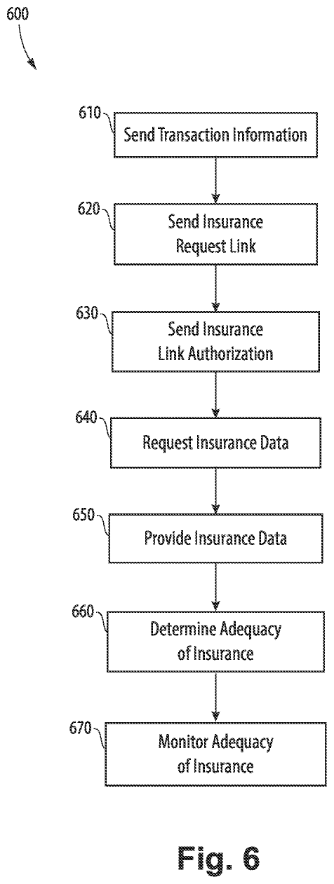

As described further below with reference to process 600 of FIG. 6, in one aspect the illustrated embodiments provide a verification computer system 103 that utilizes an API ecosystem, which may include API & data catalogues accessible by (i) parties seeking to verify a status (e.g., a business entity 107) and/or (ii) consumers (e.g., 105) seeking to have such status verified, and (iii) certain administration and configuration personnel.

In an illustrated embodiment, and as further described below with reference to process 600 of FIG. 6, the verification process 600, generally, is initiated by a dealer or property manager 107 during a transaction by causing a message to be sent to the consumer computer device 105 preferably including a link to the verifying system 103 for inputting relevant consumer data (e.g., regarding the consumer's identity, insurance carrier 106, login credentials and permissions for that carrier's site 106, data and documents). The consumer 105 responds to the message (SMS, email, other) with its credentials, which are preferably automatically entered into the verification system 103. It is to be appreciated and understood, in certain embodiments, this response may be performed manually by entering credentials or through taking a picture of their insurance card and providing additional information.

As described further below with reference to process 600 of FIG. 6, the verification system 103 preferably includes an API and RPA which uses the consumer's credentials, to access the consumer's carrier's website or database 106, after which the system 103, preferably via one or more AI/ML techniques, extracts, splits, classifies, and analyzes data and documents describing the consumer's coverage to confirm in-force status, both active and adequate. Preferably, the system 103 extracts text from carrier websites or such documents, preferably via one or more AI/ML techniques and/or identity provider (IdP) techniques, and then preferably normalizes such information into a structured data format. The system 103 then generates a verification message to the dealer/property manager 107 to confirm the existence of insurance is active or in-force and adequate (meeting specific transaction type and costumer configured). The verification message is preferably then stored as part of the transaction documents by the dealer/property manager 107 for record retention purposes (e.g., should a question arise at a later date). Upon completion of the aforesaid verification process, the system 103 may add information from the verification into a structured transactional database (234) that includes (A) the life event for which the record was created, (B) consumer contact information, (C) dealer or property manager contact information, (D) insurance policy information, and (E) carrier/agent contact information.

In accordance with an illustrated embodiment, the system 103 is configured and operative to verify the existence and coverage of automobile limits during the purchase or leasing of an automobile. For instance, and as described further below with reference to process 600 of FIG. 6, a method of use of system 103 begins with a client/consumer 105 having reached an agreement to purchase an automobile with an automobile dealer 107. As the client 105 meets with the dealership's Finance & Insurance (F&I) representative, the representative requests that the client 105 verify current insurance coverage through use of system 103, and causes a link to be transmitted through the system 103 to the client computing device 105 (e.g., via a text or email message). The system 103 then preferably generates a link for the client 105 and delivers the link, via communications network 100, to the client 105, preferably based upon its earlier indicated preference.

The client 105 then opens the link to preferably generate a web interface entry form on the client's computer device 105 (e.g., a smart phone device). The client 105 preferably enters the name of its automobile insurance carrier 106 and its log-in credentials for the carrier's website into the entry form and submits this information back to the verification system 103. The web interface entry form preferably populates the API Ecosystem (Transactional API) of verification system 103, where the client's credentials are stored. The API Ecosystem (Transactional API) of system 103 preferably initiates the verification request by supplying the consumer's credentials to an interface with insurance system 106 that authenticates the consumer's credentials via the insurance carrier's website or a direct API interface. After authentication, the interface of system 103 verifies whether the consumer has in-force insurance, including obtaining additional information, including but not limited to, coverage limits, additional automobiles insured by the carrier and expiration date. The data is then preferably sent back (verification response) to the API Ecosystem (Transactional API) of verification system 103.

In one illustrated embodiment, upon verification of in-force insurance, the API Ecosystem of system 103 generates a message to the client 105, confirming that coverage has been verified. In one embodiment, this response may further request the client 105 to change/add the vehicle to the consumer's existing coverage. At this same time, the API Ecosystem of system 103 preferably generates a notification to the dealership's F&I representative, via business entity computer system 107, also verifying the client's in-force insurance coverage that may be included in the dealership's transaction documents maintained either locally or on the system for purposes of inquiry or audit.

Other illustrated embodiments may further include (and as further described below with reference to step 670 of process 600 of FIG. 6) the verification system 103 being operative and configured (e.g., where a automobile is leased) to monitor, on a periodic basis (e.g., quarterly), in-force insurance coverage for the vehicle satisfying the requirement insurance coverage. Another embodiment may also include the delivery of coupons and other offers from an automobile dealership during the period of verification, which may be selected for redemption by the consumer. Another embodiment may also further include delivery of targeted advertising from third parties.

In certain illustrated embodiments, the verification system 103 is operative and configured to extract/download (preferably from an insurance computer system 106) in real-time, insurance documents associated with a contemplated and/or completed transaction between a client 105 and business entity 107 (including, but not limited to Auto ID cards, dec pages, etc.) preferably for storage in an electronic repository which can be accessed by a client, and/or business entity (e.g., a dealer, property manager, etc.)

In yet other illustrated embodiments, the verification system 103 is configured and operative to verify the existence and coverage of property/casualty limits during the purchase or leasing of property. One embodiment may include providing the option of purchasing insurance where coverage is known not to exist upfront (e.g., for a first-time auto buyer or renter). Another embodiment may include providing the option of updating the consumer's current insurance (e.g., by automatically adding the purchased or leased property to the consumer's policy). It is noted this significantly reduces premium leakage, where the consumer fails to notify his insurance carrier of the purchase that would increase the consumer's premium for a period of time. Yet another embodiment of verification system 103 may include, where the property is leased, the periodic, e.g., monthly, re-verification of in-force insurance coverage for the property. Another embodiment may also include the delivery of coupons and other offers from the property manager during the period of verification, which may be selected for redemption by the consumer. Another embodiment may also further include delivery of targeted advertising from third parties.

In another aspect, verification system 103 is further configured and operative to provide alerts and notifications to users/clients 105. For instance, such alerts and/or notifications may provide reminders to the client 105 to contact their agent or carrier to update their policy if the client 105 declined automatic updating during the verification process, and notifications of expired insurance coverage or credentials for accessing the carrier's systems 106. It yet other embodiments, the system 103 is operative and configured to determine, generate, and send alerts and notifications to an insurance agent and/or carrier 106, such as notices of changes/adds to the insured's policy with details of the transaction, as well as facilitate and complete endorsement, and policy changes and additions. Additionally, the verification system 103 may be operative and configured to determine, generate, and send alerts and notifications to a property manager, such as notices of expired/canceled insurance and reverification communications. It is to be further understood and appreciated that one of ordinary skill in the art would further recognize that the information utilized by the API Ecosystem of verification system 103 for verification and other purposes may further be stored and utilized for the provision of targeted advertising, lead generation, both insurance specific and other goods and services, and other purposes not directly related to the verification of in-force insurance.

It is to be understood and appreciated, and as further described below with reference to process 600 of FIG. 6, each of the above mentioned actions and/or determinations performed by the verification system 103 may preferably be performed by one or more AI/ML techniques, wherein a the verification system 103 is operatively coupled to, or integrated with one or both of the aforementioned AI device/system 300 (FIG. 3) and AI server 400 (FIG. 4).

With the exemplary system 500 (FIG. 5) being generally shown and discussed above, description of certain illustrated embodiments will now be provided with reference to the flowchart of FIG. 6. It is noted that the order of steps shown in FIG. 6 is not required, so in principle, the various steps may be performed out of the illustrated order. Also, certain steps may be skipped, different steps may be added or substituted, or selected steps or groups of steps may be performed in a separate application following the embodiments described herein.

With reference now to FIG. 6, shown is an exemplary process 600, utilizing one or more components of the aforementioned communication network 100 (FIG. 1), computing device 200 (FIG. 2), AI device 300 (FIG. 3) and AI server 400 (FIG. 4) and system 500 (FIG. 5), depicting one or more illustrated embodiments describing a computer-implemented method 600 for verifying, and/or monitoring, adequacy of insurance for a contemplated, and completed, transaction between a client and a business entity via a third party verification computer system (verification system 103). As shown and described in above exemplary system 500 of FIG. 5, the verification system 103 is preferably intermediatory between each of the client computing devices 105, a business entity computer system 107, and one or more electronic systems of an insurance company 106 associated with the client 105 (insurance company computer system).

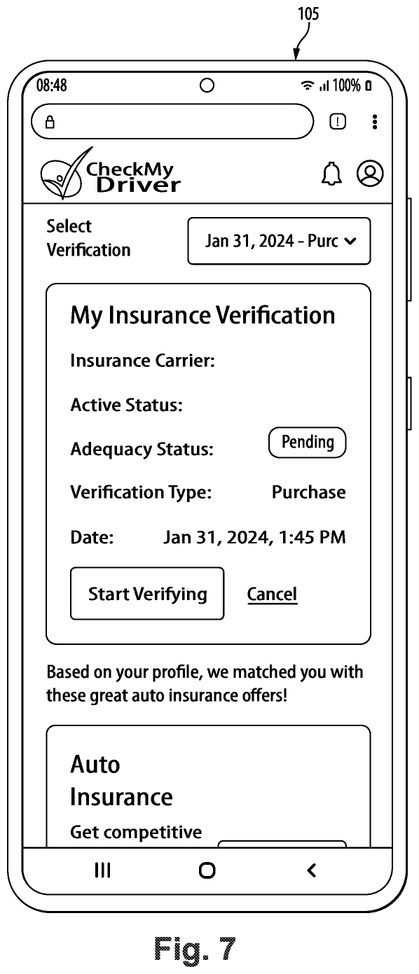

Starting at step 610, upon the occurrence of a contemplated transaction between a client 105 and a business entity 107 (e.g., leasing a vehicle, applying as a livery or gig driver, leasing an apartment, etc.) having certain insurance requirements, preferably sent from the computer system 107 associated with the business entity, via a communications network 100, is a data packet (which may be bundled via a suitable message protocol) to the verification system 103, which data indicates at least the insurance requirements for the contemplated transaction between the client 105 and the business entity 107. Next, at step 220, the verification system 103 preferably sends, via communications network 100, to a computing device 105 associated with the client (e.g., a portable computing device such as a smart phone device), a data packet requesting electronic authorization for the verification system 103 (e.g., requesting the client's log-in credentials for its insurance carrier 106) to access the insurance company computer system 106, associated with the client 105, for verifying adequacy of insurance coverage for the aforesaid contemplated transaction (see for example, FIG. 7) For instance, in certain embodiments, the data packet sent from the verification system 103 to the client computing device 105 is a Short Message Service (SMS) or Multimedia Messaging Service (MMS) message having an HTML link (Hyperlink) to a web page associated with the verification system 103 such that user selection of the Hyperlink causes a GUI to be generated on the client computing device 103 enabling the user to input information for enabling the verification system 103 (e.g., the client's log-in credentials to the insurance carrier) to access the insurance company computer system 106 for acquiring data for verifying adequacy of insurance coverage for the contemplated transaction. And in other certain embodiments, the data packet sent from the verification system 103 to the client computing device 105 is an email message having an HTML link (Hyperlink) to a web page associated with the verification system such that user selection of the Hyperlink causes the GUI to be generated on the client computing device 103 enabling the user to input information for enabling the verification system 103 to access the insurance company computer system 106 for acquiring data for verifying adequacy of insurance coverage for the contemplated transaction.

Afterwards, at step 630, the requested information (e.g., identification of an insurance company associated with the client, the client's login credentials, etc.) (via step 620) is sent/input from the client computing device 105 to the verification system 103 enabling the verification system 103 to access the identified insurance company computer system 106 associated with the client 105 for verifying adequacy of insurance coverage for the contemplated transaction. Next, at step 640, the verification system 103 sends (via communications system 100) a request to the client's aforesaid insurance company computer system 106 (preferably via an API interface) including data preferably including the client's login credentials along with data indicative of the request for the certain insurance data relating to the client's contemplated transaction with the business entity 107 (step 610). Next, at step 650, responsive to receiving the request for the client's 105 insurance information (step 640), the insurance company computer system 106, preferably upon authentication of the client's 105 aforesaid provided login credentials, the insurance company computer system 106 retrieves the requested client insurance information (e.g., insurance coverage for a vehicle or insurance coverage for rental/leased apartment) so as to then send this data to the verification system 103, via communications network 100.

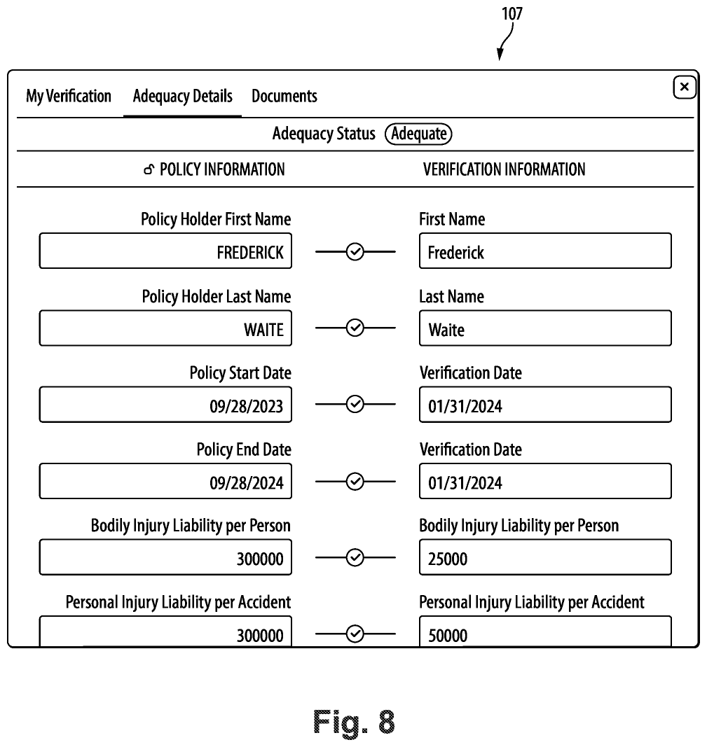

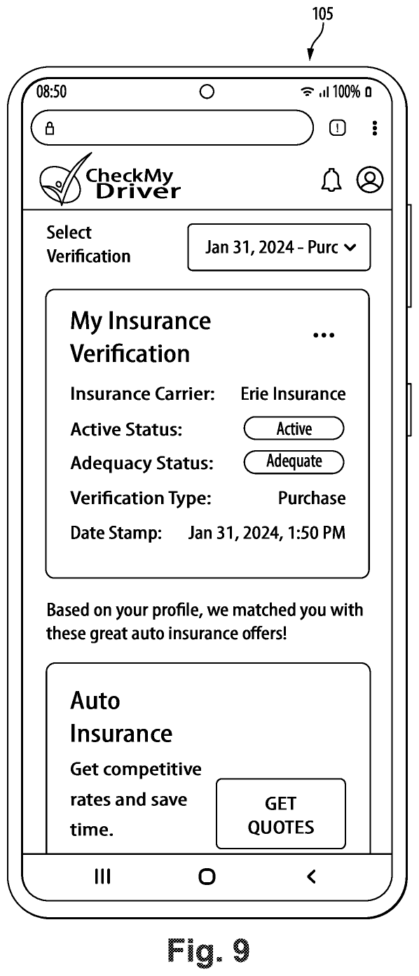

At step 660, responsive to receiving the requested insurance data from the client's insurance company computer system 106 (step 650), the verification system 103 is operative and configured to determine upon analysis of the provided insurance data, whether the client 105 has active (in-force) and adequate insurance coverage for the contemplated transaction. In certain illustrated embodiments, the verification system 103 is operative and configured to utilize one or more AI/ML techniques (e.g., via AI system 300 and AI server 400) for determining whether the client 105 has adequate insurance coverage for the contemplated transaction. For instance, this determination may include determination of whether the client 105 has one or more instances of insufficient insurance coverage required by the contemplated transaction. In certain illustrated embodiments, verification system 103 is operative and configured to cause a GUI provided on the display of one, or both of, the business entity computer system 107 (see, for example FIG. 8) and/or client computer device 105 (see, for example FIG. 9) to indicate one or more instances of sufficient and/or insufficient insurance coverage for a contemplated transaction for a respective client when the verification system 103 determines a respective client has inadequate insurance coverage for a contemplated transaction.

In certain illustrated embodiments, the verification system 103 is operative and configured, upon determination of one or more instances of insufficient insurance coverage required by the contemplated transaction, to determine and identify one or more insurance products (from either the same insurance company 106 associated with the client, or one or more different insurance companies) for providing sufficiency of insurance coverage for the contemplated transaction, without client intervention, whereby the determined one or more insurance products may be automatically provided for client selection on the GUI of the client computing device 105. In certain illustrated embodiments, the verification system 103 is operative and configured to use one or more AI/ML techniques for determining and identifying the one or more insurance products (from either the same insurance company 106 associated with the client or one or more different insurance companies) for providing sufficiency of insurance coverage for the contemplated transaction.

With reference now to step, 670, in certain illustrated embodiments, upon verification of a contemplated transaction (as described above with reference to steps 610-670), it is to be understood and appreciated the verification system 103 is further operative and configured to provide electronic monitoring of a completed transaction requiring certain insurance requirements between a client 105 and a business entity 107. For instance, and as mentioned above, the completed transaction (e.g., leasing of a vehicle, driving a vehicle associated with a business entity (e.g., Uber, DoorDash, etc.), renting an apartment, leasing a space in a building for a business purpose, etc.) has certain ongoing insurance requirements (e.g., liability coverage, collision coverage, comprehensive insurance, uninsured motorist coverage, medical payment coverage, personal injury protection, fire and/or flood insurance coverage, etc.). Thus, the verification system 103 is operative and configured to monitor these ongoing insurance requirements between the client 105 and business entity 107 to determine there has be no deviation in the client's 103 insurance coverage which will subject the client 103 to no longer have adequate insurance coverage for the aforesaid completed transaction between the client 103 and the business entity 107. For instance, did the client 103 reduce their collision coverage amount, discontinue flood insurance, etc.? Additionally, the verification system 103 may be further operative and configured to determine one or more change in life events for the client 103 (e.g., new drivers in a family, changing (or loss) of job and/or job commute distance, addition of new family members, etc.) requiring modification of the client's insurance coverage so as to maintain proper compliance with the client's insurance company 106. In accordance with the illustrated embodiments, the verification system 103 is configurable to periodically monitor the compliance of a client's insurance coverage (as well as change in life events) on a prescribed basis (e.g., monthly, quarterly, bi-yearly, yearly, etc.).

Further in accordance with the illustrated embodiments, if the verification system 103 does detect a deficiency in the required insurance coverage, and/or an aforesaid change of life event, for a completed transaction between the client 103 and a business entity 107, the verification system 103 is preferably operative to generate an alert message, which is transmitted (via communications network 100) to one, or both of, the client 103 and business entity 107 providing electronic notification of such insurance coverage deficiency and/or change of life event, requiring modification of the client's 103 insurance coverage to remain in compliance with the requirements of an aforesaid completed transaction between the client 103 and a business entity 107. In certain illustrated embodiments, the verification system 103 is further operative and configured to determine one or more remedy's (e.g., increasing collision coverage to the required amount, reacquiring insurance coverage, adding new drivers to vehicle insurance, etc.), which remedy determinations is then transmitted (via communications network 100) to one, or both of, the client 103 and business entity 107.

It is to be appreciated and understood, each of the above-mentioned actions of step 670 are preformed automatically (without user intervention) by the verification system 103 once the verification system 103 is instructed to monitor a certain client 105 for a certain completed transaction with a certain business entity 107. It is noted this is a significant advantage over prior art techniques for monitoring a client's continuing insurance requirements compliance, which was labor intensive, time consuming and costly. For instance, the verification system 103 is operative to automatically perform (without human intervention) all the above-mentioned actions of step 670 in a real-time, or near-real time basis, which was not feasible with prior techniques.

Additionally, in certain illustrated embodiments, the verification system 103 is operative and configured to use one or more AI/ML techniques, preferably utilizing AI system 300 (FIG. 3) and/or AI server 400 (FIG. 4), for performing one or more of the aforementioned actions for step 670. For instance, the verification system 103 using one or more AI/ML techniques is operative to access external databases (e.g., public records) to determine an aforesaid change in life event for a client 103 that may, or does, adversely affect the client's compliance with its insurance requirements for a particular completed transaction between the client 103 and a business entity.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer-implemented method for verifying adequacy of insurance for a contemplated transaction between a client and a business entity via a third party verification computer system (verification system) that is an intermediatory between each of the client, the business entity and one or more electronic systems of an insurance company associated with the client (insurance company computer system), comprising:
sending, from a computer system associated with the business entity, via a communications network, to the verification system, data indicative of a contemplated transaction between the client and the business entity;
sending, from the verification system to a computing device associated with the client, a data packet requesting electronic authorization for the verification system to access the insurance company computer system for verifying adequacy of insurance coverage for the contemplated transaction;
sending, from the client computing device to the verification system data enabling the verification system to access the insurance company computer system (user verification data) for verifying adequacy of insurance coverage for the contemplated transaction;
sending, from the verification system to insurance company computer system, data requesting certain insurance data relating to the client utilizing the user verification data;
sending, from the insurance company computer system to the verification system, the requested certain insurance data; and
determining, by the verification system, upon analysis of the certain insurance data, whether the client has adequate insurance coverage for the contemplated transaction.

2. The computer-implemented method as recited in claim 1, wherein the data packet sent from the verification system to the client computing device is one of a Short Message Service (SMS), Multimedia Messaging Service (MMS) or email message having an HTML link (Hyperlink) to a web page associated with the verification system such that user selection of the Hyperlink causes a GUI to be generated on the client computing device enabling the user to input information for enabling the verification system to access the insurance company computer system for verifying adequacy of insurance coverage for the contemplated transaction.

3. The computer-implemented method as recited in claim 1, wherein determining whether the client has adequate insurance coverage for the contemplated transaction includes identification of one or more instances of insufficient insurance coverage required by the contemplated transaction.

4. The computer-implemented method as recited in claim 3, further including, upon determination of one or more instances of insufficient insurance coverage required by the contemplated transaction, determining by the verification system one or more insurance products for providing sufficiency of insurance coverage for the contemplated transaction without client intervention whereby the determined one or more insurance products are provided for client selection on the GUI of the client computing device.

5. The computer-implemented method as recited in claim 4, wherein one or more Artificial Intelligence (AI) learning techniques are utilized by the verification system for determining the one or more insurance products.

6. The computer-implemented method as recited in claim 1, further including enabling the business entity computer system to have user access to electronic data relating to insurance data for one or more clients relating to either a respective contemplated transaction or completed transaction associated with each of the one or more clients wherein such electronic data indicates whether a respective client has adequate insurance coverage for a respective transaction associated with the respective client.

7. The computer-implemented method as recited in claim 1, wherein one or more Artificial Intelligence (AI) learning techniques are utilized by the verification system for determining whether the client has adequate insurance coverage for the contemplated transaction upon analysis of the certain insurance data received from the insurance company computer system.

8. The computer-implemented method as recited in claim 7, wherein the verification system further causes the GUI provided on the display of the business entity computer system to indicate one or more instances of insufficient insurance coverage for a contemplated transaction for a respective client when the verification system determines a respective client has inadequate insurance coverage for a contemplated transaction.

9. The computer-implemented method as recited in claim 3, wherein the verification system causes a display to be generated on the GUI of the client computing device to display whether a respective client has adequate insurance coverage for the contemplated transaction associated with the client.

10. The computer-implemented method as recited in claim 1, wherein the contemplated transaction relates to either a vehicle or real estate property.

11. The computer-implemented method as recited in claim 1, wherein the verification system further determines, via electronic communication with the insurance company computer system, for the completed client transaction between the client and the business entity, whether there are one or more changes to the client's insurance policy that provides inadequate insurance coverage for the completed transaction such that electronic notification is provided from the verification system to the business entity computer system indicating such inadequate insurance coverage.

12. The computer-implemented method as recited in claim 11, wherein the verification system further provides to the client's computing device electronic notification indicating inadequate insurance coverage when it is determined one or more changes to the client's insurance policy provides inadequate insurance coverage for the completed transaction.

13. The computer-implemented method as recited in claim 1, wherein the verification system further determines, for a completed client transaction between the client and the business entity, if there has been a change of life status for the client that adversely effects the client's insurance policy for the completed transaction such that electronic notification is provided from the verification system to the business entity computer system indicating such inadequate insurance coverage.

14. The computer-implemented method as recited in claim 13, wherein the verification system further provides electronic notification to the client's computing device of the inadequate insurance coverage when it is determined a change of life status for the client adversely effects the client's insurance policy for the completed transaction.

15. The computer-implemented method as recited in claim 14, wherein one or more Artificial Intelligence (AI) learning techniques are utilized by the verification system for determining the change of life status for the client.

16. A verification computer system for verifying adequacy of insurance coverage for a client relative to requirements for completing a contemplated transaction between the client and a business entity, comprising:
a memory configured to store instructions;
a processor disposed in communication with said memory, wherein said processor upon execution of the instructions is configured to:
receive data indicative of a contemplated transaction between the client and the business entity;
send to a computing device associated with the client, a data packet requesting electronic authorization for the verification computer system to access one or more electronic systems of the insurance company (insurance company computer system) associated with the client for verifying adequacy of insurance coverage for the contemplated transaction;
receive, from the client computing device, data enabling the verification system, to access the insurance company computer system for verifying adequacy of insurance coverage for the contemplated transaction;
send, to the insurance company computer system, data requesting certain insurance data relating to the client;
receive, from the insurance company computer system, the requested certain insurance data; and
determine, upon analysis of the certain insurance data, whether the client has adequate insurance coverage for the contemplated transaction.

17. The verification computer system as recited in claim 15, wherein one or more Artificial Intelligence (AI) learning techniques are utilized by the verification system for determining whether the client has adequate insurance coverage for the contemplated transaction.

18. A computer-implemented method for monitoring adequacy of insurance for a completed transaction between a client and a business entity via a third party verification/monitoring computer system (monitoring system) that is an intermediatory between each of the client, the business entity and one or more electronic systems of an insurance company associated with the client (insurance company computer system), comprising:
sending, from the monitoring system to a computing device associated with the client, a data packet requesting electronic authorization for the monitoring system to access the insurance company computer system for verifying adequacy of insurance coverage for the completed transaction;
sending, from the client computing device to the monitoring system data enabling the monitoring system to access the insurance company computer system (user verification data) for verifying adequacy of insurance coverage for the completed transaction;
sending, from the monitoring system to insurance company computer system, data requesting certain insurance data relating to the client utilizing the user verification data;
sending, from the insurance company computer system to the monitoring system, the requested certain insurance data; and
determining, by the monitoring system, upon analysis of the certain insurance data, whether the client has adequate insurance coverage for the completed transaction.

19. The computer-implemented method as recited in claim 18, wherein the monitoring system further determines if there has been a change of life status for the client that adversely effects the client's insurance policy for the completed transaction such that electronic notification is provided from the verification system to the business entity computer system indicating such inadequate insurance coverage.

20. The computer-implemented method as recited in claim 19, wherein one or more Artificial Intelligence (AI) learning techniques are utilized by the monitoring system for determining whether the client has adequate insurance coverage for the completed transaction, and for determining if there has been a change of life status for the client that adversely effects the client's insurance policy for the completed transaction.
